(19) United States
(12) Patent Application Publication
(10) Pub. No.: US 2008/0107766 A1
(43) Pub. Date: May 8, 2008

(54) SAND SCULPTING TOOL

(76) Inventor: Robert J. Cannetti, Kings Park, NY (US)

Correspondence Address: HOFFMANN & BARON, LLP, 6900 JERICHO TURNPIKE, SYOSSET, NY, 11791, US

(21) Appl. No.: 11/555,720

(22) Filed: Nov. 2, 2006

(51) Int. Cl. A63H 33/32; B28B 1/093

(52) U.S. Cl. 425/276; 446/470

(57) ABSTRACT

The present invention includes a sand sculpting tool including at least one generally planar body, The planar body includes a central portion defined by a dominant silhouette of the body. Also, the planar body includes at least one sculpting feature substantially protruding from the dominant silhouette. The sculpting feature being substantially disposed in a common plane with the body. Further, the sculpting feature includes a unitary protruding shape capable of forming a solitary impression of the shape in the sand.

### BACKGROUND OF THE INVENTION

The present invention related to a sculpting tool and/or device, particularly for sculpting sand.

The creation of sand castles and countless other sand sculptures/structures is a common and popular pastime. The types of creations range from simple to very elaborate works. While the most simple sand carvings or sculptures can be made by hand without assistance of tools, the more elaborate creations are generally made with the aid of some implement.

In the past, custom tools have been provided to aid in the construct of more detailed sand sculptures, such as those shown in U.S. Pat. No. 5,585,123 to Busby and U.S. Pat. No. 6,415,926 to Long. These patents show tools with handles and sculpting heads that protrude three-dimensionally. Other, more planar tools are shown in U.S. Pat. No. 4,455,752 to Koulouras or Koulouras or U.S. Pat. No. 5,739,293 to Kelly et al., wherein a jagged edge or repeating pattern is provided on one or two sides of a tool so that the tool has been referred to as a “jagged tool.” However, such jagged tools only permit creation of patterned surfaces and preclude exquisite sculpting using a tool wherein the sculpting head or feature extends as a sand-carving-scalpel from a plane edged body. Additionally, such tools are either bulky or do not provide refined features for detailing a sand sculpture.

Thus, it is desirable to provide a sand sculpting tool which overcomes the shortcomings found in the art of sand sculpting as set forth above while also providing an improved versatile implement that is easy to use, light-weight, not bulky and is easily transported.

### SUMMARY OF THE INVENTION

The present invention includes a sand sculpting tool having at least one generally planar body. The planar body includes a central portion define by a dominant silhouette of the body. Also, the planar body includes at least one sculpting feature substantially protruding from the dominant silhouette. The sculpting feature being substantially disposed in a common plane with the body. Further, the sculpting feature includes a unitary protruding shape capable of forming a solitary impression of the shape in the sand.

Additionally, the above mentioned device can alternatively include more than one sculpting feature. Each of the sculpting features can include and outermost portion which protrudes in a different direction from each other outermost portion of each other sculpting feature relative to the dominant silhouette. Also, all the sculpting features on a single planar body can have a similar shape. Additionally, the sculpting features can include a semicircular or other common geometric shape. The above planar body cab further include at least one straight edge. The straight edge can and outermost edge of a peripheral side of the planar body. Further still, the at least one generally planar body can include at least one cross-sectionally tapered edge and/or and adjustable shape characteristic.

Further, the above mentioned device can alternatively include at least two planar bodies pivotally secured to one another. The at least two planar bodies each can include at least one straight edge, whereby the straight edges are an outermost edge of an outer periphery of the planar body. Also, the at least two planar bodies can each further include at least one curved edge opposite the straight edge. The curved edges can be an outermost edge of an outer periphery of the planar body. Further, each sculpting features can be substantially different from each other sculpting feature.

Another aspect of the present invention, includes a sand sculpting tool including more than one generally planar body. Each planar body includes a sculpting feature on a peripheral edge and a coupling portion remote to the peripheral edge. Each planar body further includes a coupling member pivotally securing the coupling portions of the generally planar bodies.

Additionally, the above mentioned tool with multiple planar bodies can include sculpting features having an outer shape for sculpting in the sand that is different from every other sculpting feature. Also, the planar bodies can each include at least one straight edge capable of smoothing an area of sand. Additionally, at least one of the planar bodies can include at least one curved edge apart from the sculpting feature, the curved edge capable of forming a similarly curved depression in the sand. Further, at least two of the planar bodies can include the curved edge, wherein at least one pivotally offset position of two of the at least two planar bodies defines a silhouette of a continuous curve. The length of the continuous curve being longer than a single one of the curved edges. Further still, at least one of the planar bodies can be removeably secured by the coupling member.

As a result of the present invention an apparatus is provided for creating exquisite detail in sand and other sculptures. Also, the apparatus is versatile, portable, not bulky or heavy and is easy to use.

These and other objectives, features, and advantages of this invention will become apparent from the following detailed description of illustrative embodiments thereof, which is to be read in connection with the accompanying drawings.

### BRIEF DESCRIPTION OF THE DRAWINGS

FIG. 1 is a plan view of a sand sculpting tool in accordance with the subject invention.

FIG. 2A is a cross-sectional view of the sand sculpting tool in FIG. 1, at section line 2A-2A therein.

FIG. 2B is a side view of a portion of the sand sculpting tool in FIG. 1, from vantage lines 2B therein.

FIG. 2C is a side view of a portion of the sand sculpting tool in FIG. 1, from vantage lines 2C therein.

FIG. 3A-3F are plan views of a user holding the sand sculpting tool in FIG. 1 in various different orientations.

FIG. 4 is a perspective view of a sand sculpture, including the sand sculpting tool in FIG. 1 used to form five different sculpted features of the sand sculpture.

FIG. 5A is a plan view of an alternative sand sculpting tool in accordance with the subject invention.

FIG. 5B is a side view of the sand sculpting tool in FIG. 5A, from vantage lines 5B therein.

FIG. 6A is a plan view of a further alternative sand sculpting tool in accordance with the subject invention.

FIG. 6B is a plan view of a further alternative protruding sculpture feature in accordance with the subject invention.

FIG. 6C is a plan view of a further alternative protruding sculpting feature in accordance with the subjective invention.

FIGS. 7A-7E are perspective views of yet a further alternative sand sculpting tool with two pivotally secured planar bodies in various pivotal orientations, in accordance with the subject invention.

FIGS. 8A-8D are perspective views of yet a further alternative sand sculpting tool with multiple pivotally secured planar bodies in various pivotal orientations, in accordance with the subject invention.

FIGS. 9A-9C are perspective views of yet a further alternative sand sculpting tool with multiple pivotally secured planar bodies in various pivotal orientations, in accordance with the subject invention.

FIG. 10A is perspective views of yet a further alternative sand sculpting tool with multiple pivotally secured planar bodies in a closed orientation, in accordance with the subject invention.

FIG. 10B is perspective views of the sand sculpting tool of FIG. 10A with one of multiple pivotally secured planar bodies in a deployed pivotal orientation, in accordance with the subject invention.

FIG. 11A is a plan view of a further alternative sand sculpting tool in accordance with the subject invention.

FIG. 11B is a cross-sectional view of the sand sculpting tool in FIG. 11A, at the lines 11B.

FIG. 12A-12C are perspective views of the sand sculpting tool of FIG. 11A.

### DETAILED DESCRIPTION OF THE DRAWINGS

The present invention relates to a sand sculpting device that provides numerous advantages over the prior art. The device is relatively simple and easy to operate and/or use. Designed to be light-weight and have a small profile, the device is preferably relatively easy transport. In this way, it can be carried by an individual in a small pocket or many different containers. Also, this preferably allows a user to manipulate the device more easily while sculpting. The sculpting tool of the present invention provides detail oriented sculpting features, preferably for sand sculptures. However, while the present invention is particularly described as it relates to sand sculpting, it should be understood that the tool could also be used with virtually any other pliable sculpting medium.

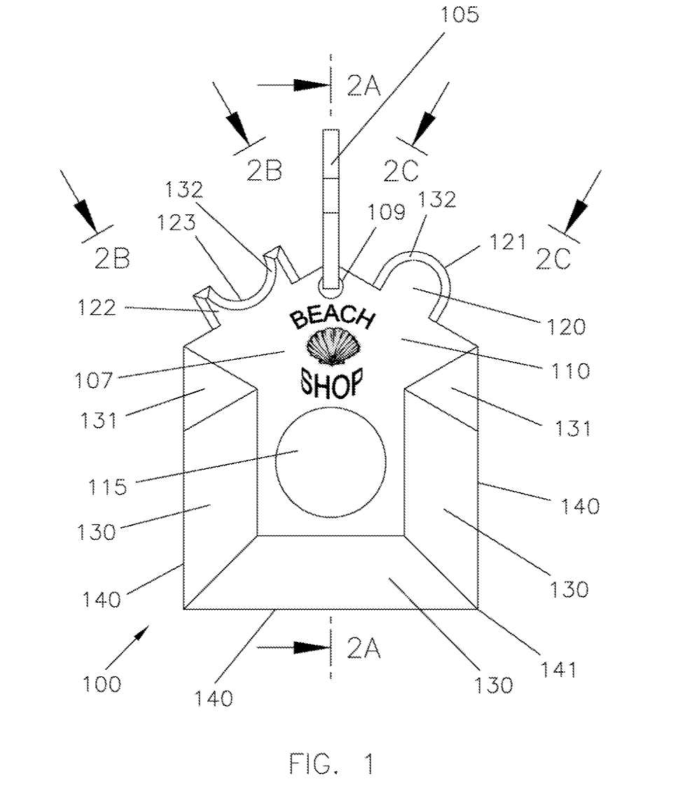

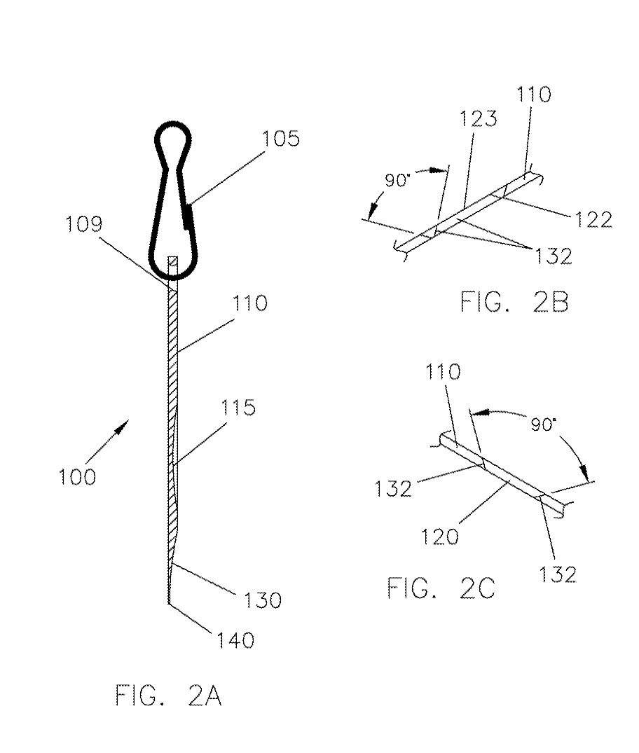

With reference to drawings, FIGS. 1 and 2A-C show a sand sculpting tool 100 including a planar body 110 and various features in accordance with an embodiment of the present invention. The body 110 is preferably formed as a thin unitary sheet or web of rigid or semi-rigid material capable of retaining its shape. The body 110, shown in FIG. 1, has a main body portion or dominant silhouette in the form of a pentagon. The “dominant silhouette” as a referred to herein, means the shape of the body of the tool without the protruding unitary sculpting feature(s). This, in contrast to sculpting features in prior art tools, such as a serrated edges, where a distinct silhouette without the protruding sculpting feature is not discernable. However, it should be understood that more stylized shapes or other geometrical shapes could be provided for the dominant silhouette of the body 110. For example, the dominant silhouette could be made in form of a unique non-descript shape or a more recognizable form, such as a shark, seashell, starfish or lighthouse. Alternatively, other geometrical shapes such as a triangle, rectangle, hexagon, etc. could be used to form the dominant silhouette of the body. Also, a more less equilateral form could be provided for the dominant silhouette. As shown in FIG. 1, uninterrupted surface spaces 107 of the body 110 can be used for logos, names, initials or other personalized indicia.

The body 110 can be employed as a stand-alone tool or combined with other similar body forms to provide additional sculpting features. For example, a coupling member, such as the retaining clip 105, could be used to hold additional tools 100, perhaps with variations in the sculpting features provided thereon. Alternatively, the body 110 can be used without retaining clip 105 or any coupling member attached thereto. The aperture 109 is preferably provided for just such a coupling member, but alternatively could be filled-in or does not need to be included.

Preferably, the tool 100 includes at least one sculpting feature 120 protruding from an edge of the planar body 110. In order to maintain a slim flat profile for the overall tool 100, the sculpting feature is preferably also planar and disposed in the same plane as the body 110. Thus, the tool 100 can be sized to fit in a shirt pocket or other small storage space. Also, one or more additional sculpting features 122 can be provided to give a sand sculptor a more versatile tool that is capable of carving exquisite detail in the sand or other sculpting medium. The particular protruding sculpting features 120, 122 include and outer edge 121, 123 that defines and/or characterizes the impression it will make in the sand. In particular, edges 121, 123 both have similar semi-circular shapes. However, they are noticeably different in that edge 121 has a convex configuration, while edge 123 has a concave configuration.

The tool 100 also preferably includes at least one substantial straight edge 140, useful as a smoothing sculpting feature. This feature 140 is preferably incorporated into the dominant silhouette of the body 110, but could also be formed as a protruding sculpting feature. It should be understood that while three peripheral edges in FIG. 1 have a straight edge 140, other non-linear sculpting features could be provided on these edges. Also, the three lower peripheral edges seen in FIG. 1, need not all be the same. In this way, curved, patterned or other edge formations can be integrated into the main body 100. It is preferred that at least one pointed or relatively sharp corner 141 be provided. This too can be used as a fine-point sculpting feature.

The body 110 is also preferably provided with one or more forms of taper on many edges. As shown in FIG. 2A, the body 110 preferably has a shallow taper 130 along straight edge 140. Such as long tapered edge can be used to carve a straight line, with the thickness of such a line gauged by how deep the tool 100 is inserted into the sand. Similarly, the three lower edges seen in FIG. 1 need not have edges with similar thickness or taper. Additionally, a transitional tapered edge 131 can be provided between tapered and non-tapered edges, or even between edges of differing tapered thickness.

Further, the outer edges 121, 123 of the sculpting features 120, 122 preferably have a taper 132, particularly shown in FIGS. 2B and 2C. The taper 132 shown in at a 45° angle from the plane of the body 110, such that opposed edges of the taper 132 form a 90° angle. It should be understood, however, that other angles of taper or even no taper could be provided. Also, the tapered edges 130, 131, 132 described herein do not need to be linear. For example, those edges 130, 131, 132 could have a curved or stepped taper.

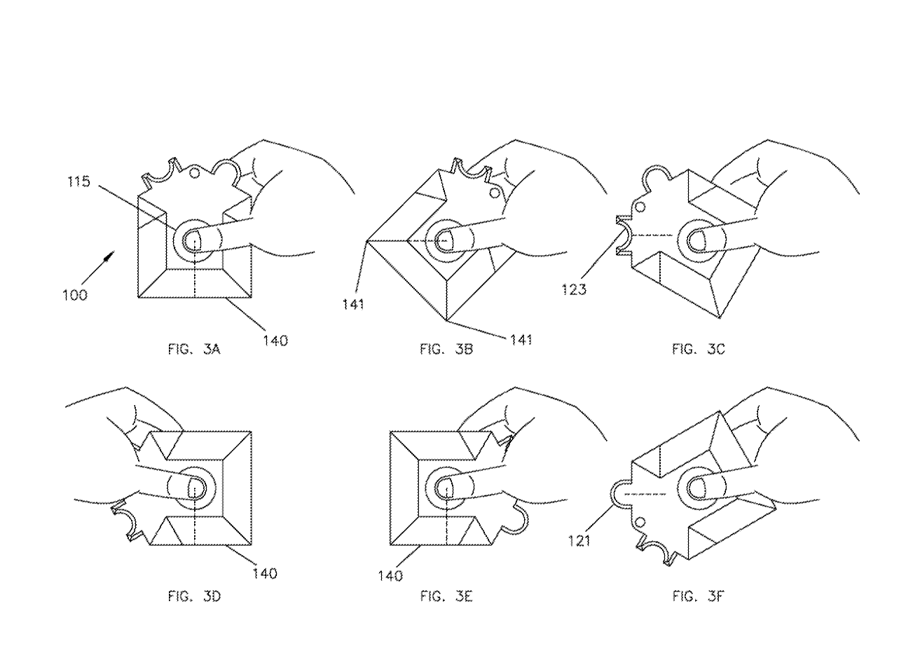

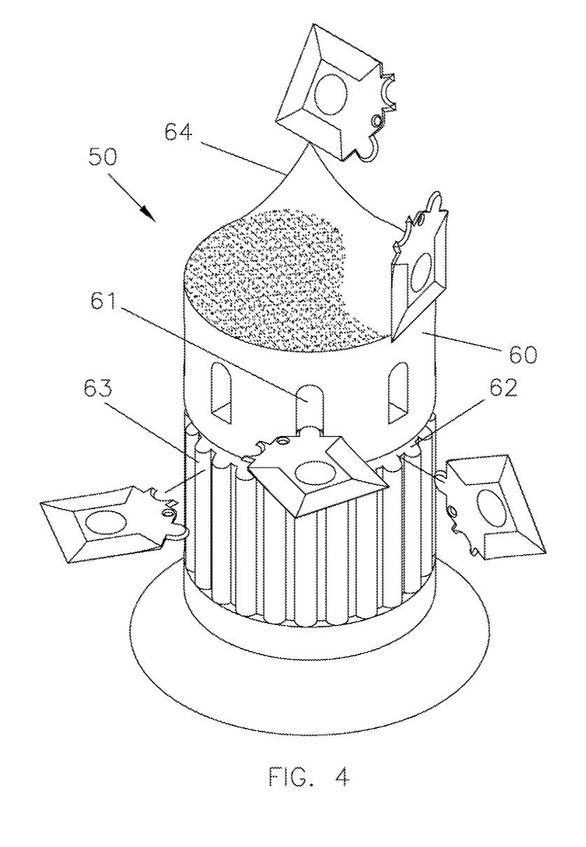

FIGS. 3A-3F show the tool 100 held by user's hand in various orientations. The dashed line in each figure extends between the user's thumb and the intended sculpting feature to be used in each particular configuration. For example, FIG. 3A shows the lower edge 140 being used. Alternatively, FIG. 3B shows the left corner 141 being used. Additionally illustrated is how the ergonimic grip depression 115 is used when handling the tool 100. Similarly, FIG. 4 illustrates the tool 100 used to form various different sculpted features of a sand sculpture 50. As shown the straight edge 140 can be used to form smooth side walls 60 or more stylized finishes, such as the tear-shaped peak 64. The protruding convex semi-circular edge 121 can be used to form a depression 61 with the similar curved characteristics. Also, the edge 121 can create curved edges 62. The protruding concave semi-circular edge 123 can create columns 63 and other similar forms.

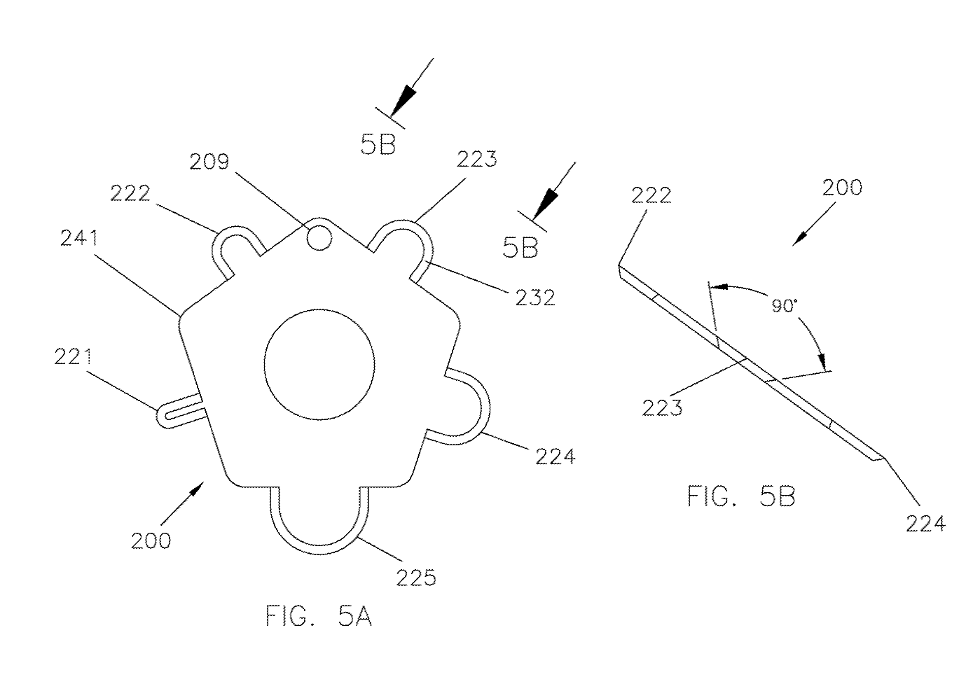

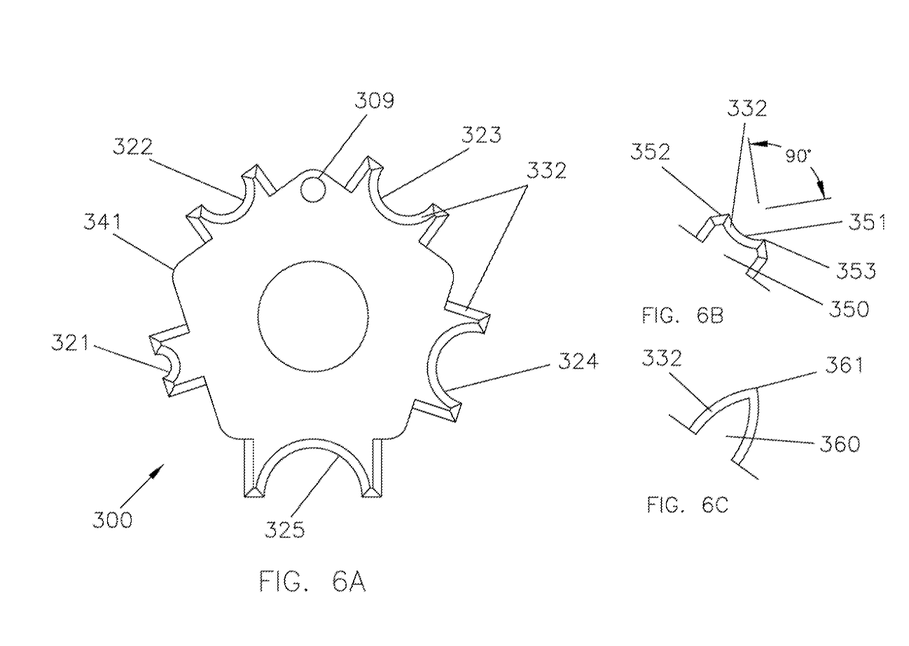

Further embodiments are shown in FIGS. 5A, 5B and 6A which illustrate sculpting too 200, 300. These embodiment also have a pentagonal shape, however, as discussed above it should be understood that the tool(s) could be constructed with other shapes as is known in the art. Thus, these embodiments preferably include varied protruding sculpting features 221-225, 321-325. All the sculpting features in each tool 200, 300 are similar to one another in that they have a semi-circular convex/concave shape, however they each have a varied radial curvature. As with the previous embodiment, the remote edges of the sculpting features preferably include a tapered edge 232, 332. Also, the tools 200, 300 preferably include an aperture 209, 309 for a ring, fastening clip or other coupling member. The corners 241, 341 are shown rounded-off, however alternatively sharp or truncated corners could be provided. FIGS. 6B and 6C show further variations that can be provided for the sculpting features 350, 360. In particular, sculpting feature 350 includes an arch or incomplete semi-circular shape 351. Dual protruding truncated tips 352 are preferably provided in this embodiment that also includes sharp points 353 that can be used for carving parallel lines. As a further alternative, the spear-head design on protruding sculpting feature 360, includes a single pointed tip 361.

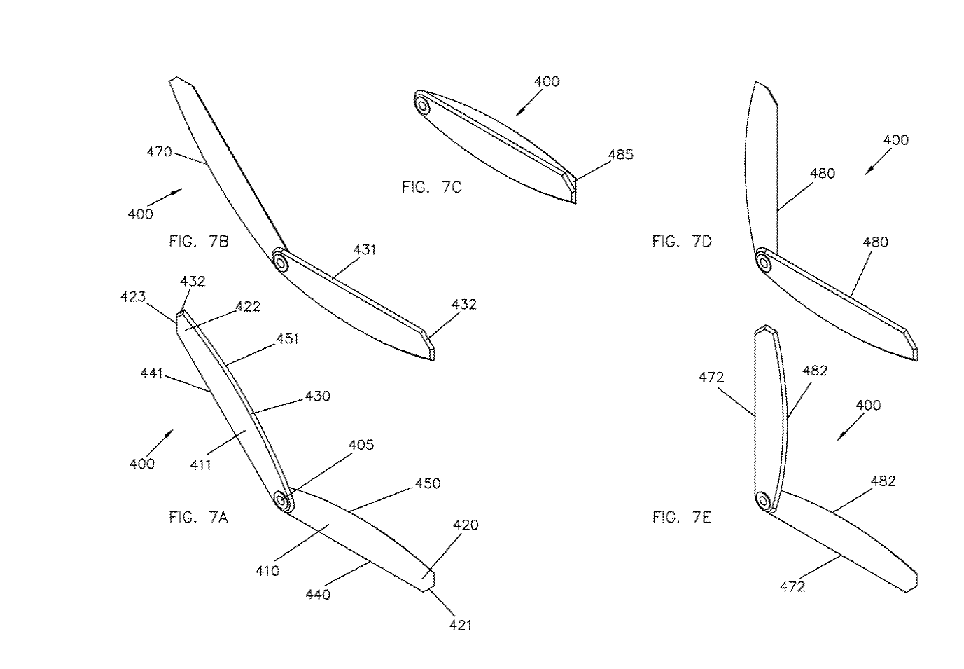

FIGS. 7A-7E show a further embodiment of the present invention that includes two planar bodies 410, 411 secured by a pivotal coupling member 405. The planar bodies 410, 411 preferably have a generally more elongate form, with each one having only one protruding sculpting feature 420, 422. Each of the sculpting features 420, 422 include respective outer edges 421, 423 and preferably their own bevel or taper 432. FIG. 7C shows a closed position for the tool 400, wherein the two bodies 410, 411 substantially overlap. The symmetrically opposite design of bodies 410, 411 provides an overhang 485, in the closed position, which facilitates pivotal rotation of the bodies 410, 411 away from the closed position. The pivotal nature of the coupling 405, provides various “open” positions that can be configured, by rotationally displacing one or both of the bodies 410, 411, like the hands on a clock. The pivotal coupling 405 can be designed to either permanently or releasably secure the two bodies 410, 411. Also, the pivotal coupling 405 can include features for measuring the angle between the two bodies to 410, 411. Further the coupling 405 could have one or more pivotal configurations that are provided with a mark or retention mechanism for maintaining or biasing the bodies to remain oriented at a selectively chosen angle relative to one another.

As with the first embodiment above, the bodies 410, 411 preferably include a flat edge 440, 441. Such flat edges 440, 441 can be used individually or in combination. For example, as shown in FIG. 7D, by properly orienting the two bodies 410, 411 at ninety degrees to one another (forming an L-shape) with the straight edges 440, 411 on the inner angle 480, the tool 400 can be used to create protruding corners or other protruding right angle features. Similarly, another orientation shown in FIG. 7E places the straight edges on the outside 472, providing a tool that can make recessed right angles. Further, the tool 400 preferably includes gradually curved edges 450, 451. These edges 450, 451 can also be used in combination. For example, as shown in FIG. 7B, the proper pivotal orientation of the bodies 410, 411 provides a large continuous curve 470. Additionally, the inverse orientation, shown in FIG. 7E, shows the two curved edges 450, 451, forming a unique inner angle 482. Further still as with previous embodiments, tapered edges 430, 431 are preferably provided.

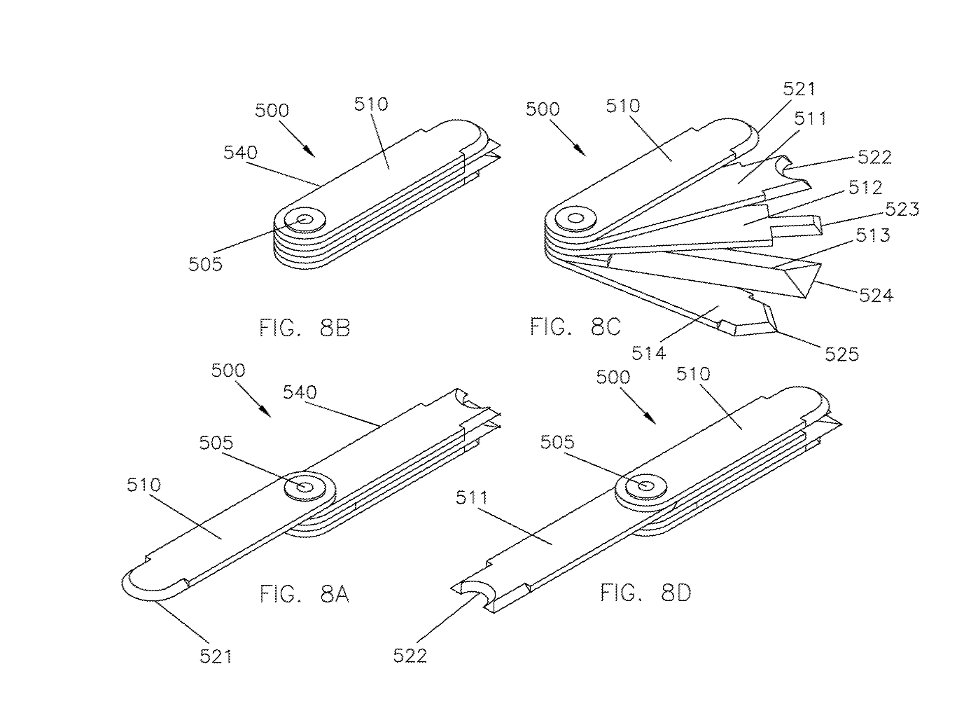

FIGS. 8A-8D show a further embodiment of the present invention, providing sculpting tool 500 with a set of elongate bodies 510-514, each having a unique sculpting feature 521-525 at one end. Also, the elongate bodies 510-514 include opposed straight edges 540. FIG. 8B shows the tool 500 in the closed position. The bodies 510-514 are secured by pivotal coupling 505, which preferably allows a single body to be rotated away from the closed position, as shown in FIGS. 8A and 8D. It should be understood that while five (5) are shown, a greater or lesser number of bodies could be provided. Also, the shapes of the particular sculpting features could be changed and/or rearranged as desired when assembling the tool 500. Further, the pivotal coupling 505 could be located in a more central location of the elongate bodies, thus allowing for additional sculpting features on both ends of the bodies.

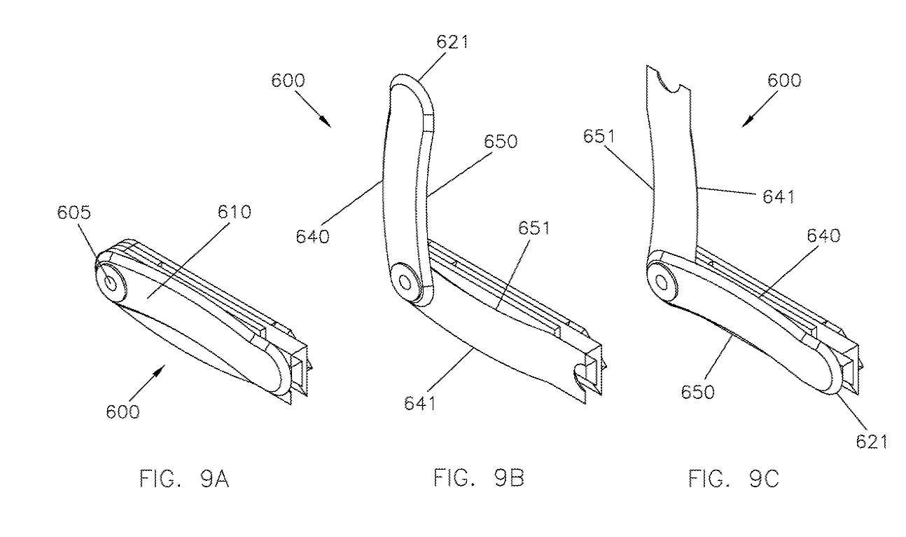

FIGS. 9A-9C shows yet a further embodiment of the present invention, providing sculpting tool 600. This embodiment is similar to the previous sculpting tool 500 in that it provides a set of bodies 610, each with a unique sculpting feature 621. Also, the tool provides a pivotal coupling 605 that secures the bodies 610. However, the tool 600 further preferably provides at least two of the bodies 610 with curved elongate edges 640, 641, 650, 651. As described with regard to the previous embodiments, the curved edges 640, 641, 650, 651 can be used in combination to sculpt curved surfaces that extend the length of almost two entire bodies 610.

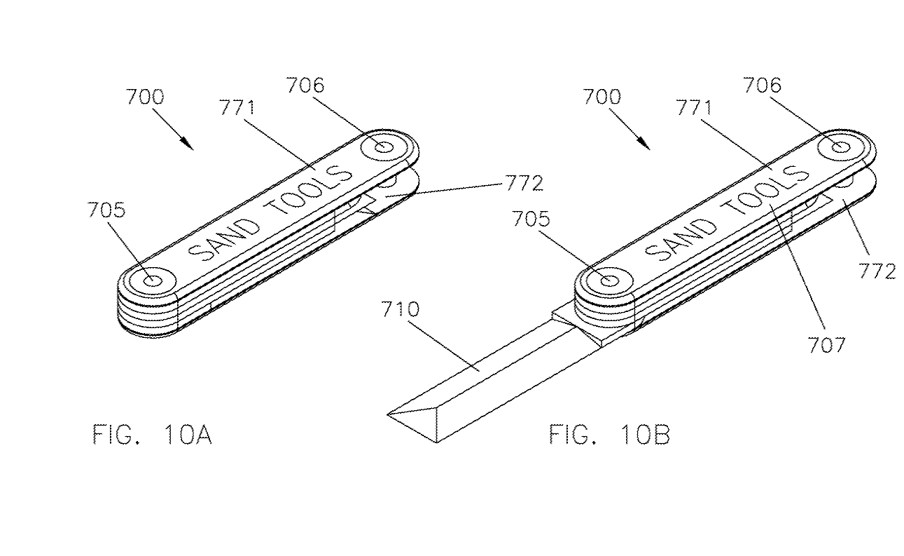

FIGS. 10A-10B show yet a further embodiment of the present invention, providing sculpting tool 700. Once again, this embodiment has multiple sculpting bodies, similar to sculpting tool 500. In addition sculpting tool 700 includes two outer bodies 771, 772 that are secured at opposed ends by coupling members 705, 706. As with the previous embodiment, at least one of the coupling members 705 should provide a pivotal coupling for the inner bodies 710. The outer bodies 771, 772 provide an outer casing for the inner bodies 710 and can be made from a more durable material. Also, the outer bodies 771, 772 can include surface spaces 707 that can be used for logos, names, initials or other personalized indicia.

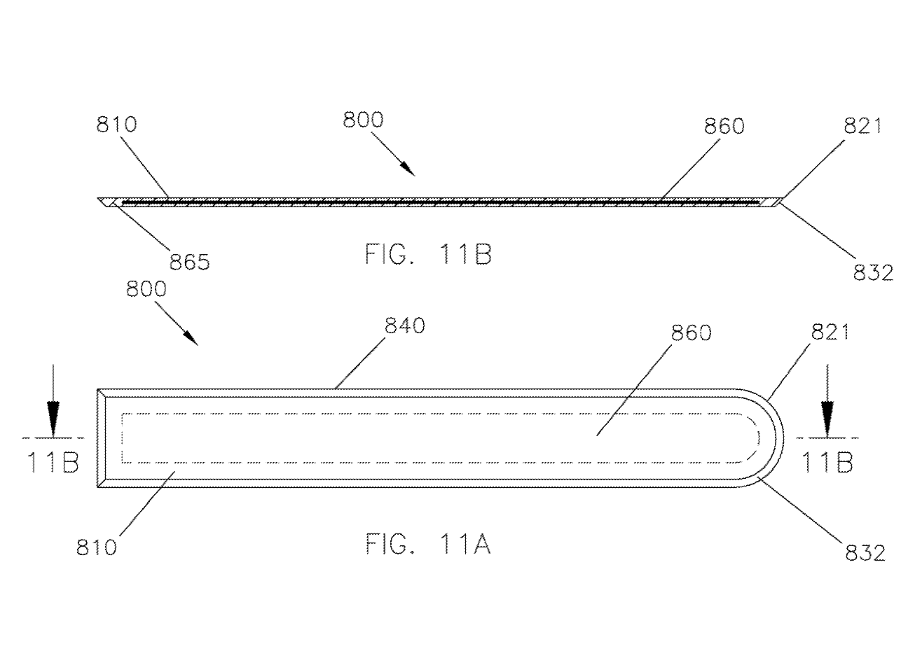

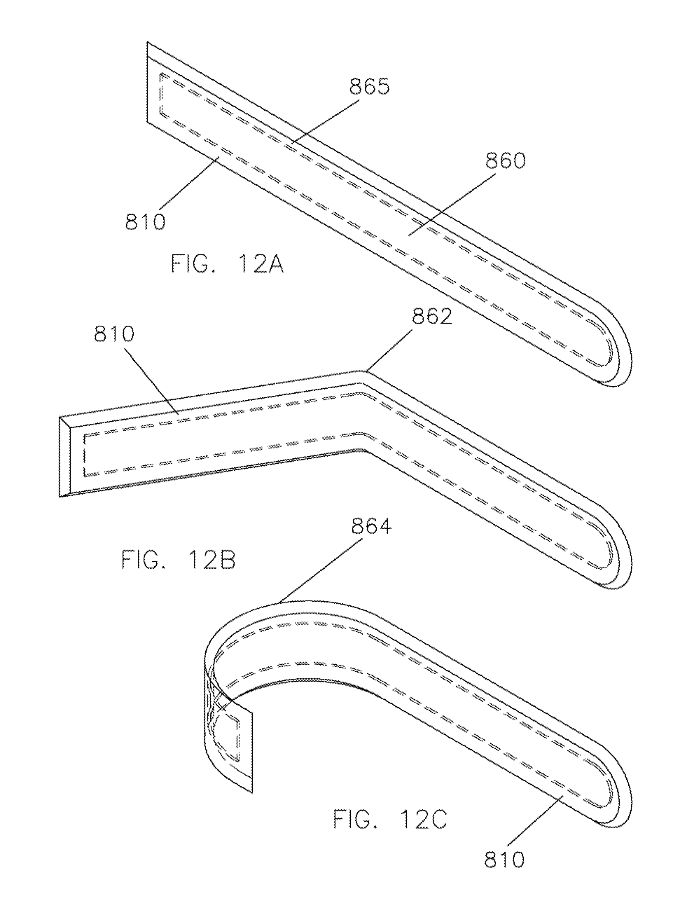

FIGS. 11A-12C show yet a further embodiment of the present invention, providing a sculpting tool 800 with a body 810 that includes a protruding sculpting feature 821, tapered surfaces 832 and straight edges 840. Additionally, this embodiment includes a flexible design, which allows the body 810 to be bent, curved or even twisted out-of-plane, as shown in FIGS. 12B and 12C. FIG. 12A shows the body 810 before it is bent out of plane. Rather than being formed of a rigid material, the otherwise planar body 810 is preferably design to bend and hold a desired shape. Thus, an inner core 860 is preferably provided that is made of a suitable metal or other material that is both pliable and can hold its shape. Also, the inner core 860 can be coated or encased in an outer shell 865 of rubber, plastic or other flexible, yet durable material. In this way, the body 810 will have an adjustable shape characteristic that allows a user to form and retain sharp bends 862, as shown in FIG. 12B curves 864, as shown in FIG. 12C, or other customized shapes (not shown). An “adjustable shape characteristic” as referred to herein means the shape if the body can be easily changed and the body can retain that changed shape. It should be understood, that all of the prior embodiments could alternatively be formed to include this adjustable shape characteristic.

While various embodiments of the present invention are specifically illustrated and/or described herein, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A sand sculpting tool comprising:
at least one generally planar body including a central portion defined by a dominant silhouette of said body, and at least one sculpting feature substantially protruding from said dominant silhouette and substantially disposed in a common plane with said body, said sculpting feature having a unitary protruding shape capable of forming a solitary impression of said shape in the sand.

2. The sand sculpting tool according to claim 1, wherein said at least one sculpting feature, wherein each sculpting feature, wherein each sculpting feature includes and outermost portion which protrudes in a different direction from each other outermost portion of each other sculpting feature relative to said dominant silhouette.

3. The sand sculpting tool according to claim 2, wherein all the sculpting features on a single planar body have a similar shape.

4. The sand sculpting tool according to claim 1, wherein the said planar body further includes at least one straight edge, whereby said straight edge is an outermost edge of a peripheral side of said planar body.

5. The sand sculpting tool according to claim 1, wherein the said at least one generally planar body includes at least one cross-sectionally tapered edge.

6. The sand sculpting tool according to claim 1, wherein the said at least one sculpting feature includes a semicircular shape.

7. The sand sculpting tool according to claim 1, wherein said at least one generally planar body includes at least two planar bodies pivotally secured to one another.

8. The sand sculpting tool according to claim 7, wherein said at least two planar bodies each include at least one straight edge, whereby said straight edges are an outermost edge of an outer periphery of said planar body.

9. The sand sculpting tool according to claim 8, wherein said at least two planar bodies each further include at least one curved edge opposite said straight edge, whereby said curved edges are an outermost edge of an outer periphery of said planar body.

10. The sand sculpting tool according to claim 7, wherein each sculpting features is substantially different form each other sculpting feature.

11. The sand sculpting tool according to claim 1, wherein said planar body includes an adjustable shape characteristic.

12. A sand sculpting tool comprising:
more than one generally planar body including a sculpting feature on a peripheral edge and a coupling portion remote to said peripheral edge; and
a coupling member pivotally securing said coupling portions of said generally planar bodies.

13. The sand sculpting tool according to claim 12, wherein each of said sculpting features includes an outer shape for sculpting in the sand that is different from every other sculpting feature.

14. The sand sculpting tool according to claim 12, wherein said planar bodies each include at least one straight edge capable of smoothing an area of sand.

15. The sand sculpting tool according to claim 12, wherein at least one of said planar bodies includes at least one curbed edge apart from said sculpting feature, said curved edge capable of forming a similarly curved depression in the sand.

16. The sand sculpting tool according to claim 15, wherein at least two of said planar bodies include said curved edge, and wherein at least one pivotally offset position of two of said at least two planar bodies defines a silhouette of a continuous curve, wherein a length of said continuous curve is longer than a single one of said curved edges.

17. The sand sculpting tool according to claim 12, wherein at least one of said planar bodies is removeably secured by said coupling member.

18. The sand sculpting tool according to claim 12, wherein at least one of said planar bodies includes an adjustable shape characteristic.
